(19) United States
(12) Patent Application Publication
(10) Pub. No.: US 2012/0278550 A1
(43) Pub. Date: Nov. 1, 2012

(54) SYSTEM ARCHITECTURE BASED ON RAID CONTROLLER COLLABORATION

(76) Inventors: Byungcheol Cho, Seochogu (KR); Moon J. Kim, Wappingers Falls, NY (US)

(21) Appl. No.: 13/094,115

(22) Filed: Apr. 26, 2011

(51) Int. Cl. G06F 12/00; G06F 12/16

(52) U.S. Cl. 711/114; 711/103; 711/E12.001; 711/E12.103

(57) ABSTRACT

Embodiments of the present invention provide a semiconductor storage device (SSD) system based on redundant array of independent disks (RAID) controller collaboration. Specifically, embodiments of the present invention provide a set (at least one) of RAID controllers coupled to a host system, wherein each of the set of RAID controllers is configured to collaborate with at least one other RAID controller within the set through at least one dedicated controller-to-controller channel to enable high bandwidth RAID storage.

### CROSS-REFERENCE TO RELATED APPLICATION

This application is related in some aspects to commonly-owned, co-pending application Ser. No. 12/758,937, entitled SEMICONDUCTOR STORAGE DEVICE”, filed on Apr. 13, 2010. This application is also related in some aspects to commonly-owned, co-pending application Ser. No. 12/763,701, entitled RAID CONTROLLED SEMICONDUCTOR STORAGE DEVICE”, filed on Apr. 20, 2010. This application is also related in some aspects to commonly-owned, co-pending application Ser. No. 12/763,688 entitled RAID CONTROLLER FOR A SEMICONDUCTOR STORAGE DEVICE”, filed on Apr. 20, 2010. This application is also related in some aspects to commonly-owned, co-pending application Ser. No. 12/848,281, entitled “HYBRID RAID CONTROLLER”, filed on Aug. 2, 2010.

### FIELD OF THE INVENTION

The present invention relates to a semiconductor storage device (SSD) system based on redundant array of independent disks (RAID) controller collaboration. Specifically, the present invention relates to a set of RAID controllers configured to collaborate with each other through dedicated controller-to-controller channels to enable high bandwidth RAID storage.

### BACKGROUND OF THE INVENTION

As the need for more computer storage grows, more efficient solutions are being sought. As is known, there are various hard disk solutions that store/read data in a mechanical manner as a data storage medium. Unfortunately, data processing speed associated with hard disks is often slow. Moreover, existing solutions still use interfaces that cannot catch up with the data processing speed of memory disks having high-speed data input/output performance as an interface between the data storage medium and the host. Therefore, there is a problem in the existing area in that the performance of the memory disk cannot be property utilized.

### SUMMARY OF THE INVENTION

Embodiments of the present invention provide a semiconductor storage device (SSD) system based on redundant array of independent disks (RAID) controller collaboration. Specifically, the present invention relates to a set of RAID controllers configured to collaborate with each other through dedicated controller-to-controller channels to enable high bandwidth RAID storage.

A first aspect of the present invention provides a semiconductor storage device (SSD) system architecture based on redundant array of independent disks (RAID) controller collaboration, comprising: a controller switch coupled to a host computer; a set of RAID controllers coupled to the controller switch, wherein each of the set of RAID controllers is adapted to collaborate with at least one other RAID controller within the set; and a set of storage drives coupled to each of the set of RAID controllers.

A second aspect of the present invention provides a method for providing a semiconductor storage device (SSD) system architecture based on redundant array of independent disks (RAID) controller collaboration, comprising: a controller switch coupled to a host computer; a set of RAID controllers coupled to the controller switch, wherein each of the set of RAID controllers is adapted to collaborate with at least one other RAID controller within the set; and a set of storage drives coupled to each of the set of RAID controllers.

A third aspect of the present invention provides a configurable disk array system for controlling, storing, and retrieving of data in RAID format, comprising: a controller switch coupled to a host computer; a set of RAID controllers coupled to the controller switch, wherein each of the set of RAID controllers is adapted to collaborate with at least one other RAID controller within the set; and a set of storage drives coupled to each of the set of RAID controllers.

### BRIEF DESCRIPTION OF THE DRAWINGS

These and other features of this invention will be more readily understood from the following detailed description of the various aspects of the invention taken in conjunction with the accompanying drawings in which:

FIG. 1 is a diagram schematically illustrating a configuration of a RAID controlled storage device of a PCI-Express (PCI-e) type according to an embodiment of the present invention.

FIG. 2 is a diagram of the hybrid RAID controller of FIG. 1.

FIG. 3 is a diagram schematically illustrating a configuration of the high-speed SSD of FIG. 1.

FIG. 4 is a diagram schematically illustrating a configuration of a controller unit in FIG. 1.

FIG. 5A is a diagram schematically illustrating a configuration of a conventional wide bandwidth RAID.

FIG. 5B is a diagram schematically illustrating a configuration of a collaborating wide bandwidth RAID.

FIG. 6A is a diagram schematically illustrating a switch enabled to distribute the data load to a set of collaborating RAID controllers.

FIG. 6B is a diagram schematically illustrating a switch adapted to intercept and dynamically forward data to enable controller-to-controller communication for wider bandwidth.

The drawings are not necessarily to scale. The drawings are merely schematic representations, not intended to portray specific parameters of the invention. The drawings are intended to depict only typical embodiments of the invention, and therefore should not be considered as limiting the scope of the invention. In the drawings, like numbering represents like elements.

### DETAILED DESCRIPTION OF THE INVENTION

Exemplary embodiments will now be described more fully herein with reference to the accompanying drawings, in which exemplary embodiments are shown. This disclosure may, however, be embodied in many different forms and should not be construed as limited to the exemplary embodiments set forth therein. Rather, these exemplary embodiments are provided so that this disclosure will be thorough and complete and will fully convey the scope of this disclosure to those skilled in the art. In the description, details of well-known features and techniques may be omitted to avoid unnecessarily obscuring the presented embodiments.

The terminology used herein is for the purpose of describing particular embodiments only and is not intended to be limiting of this disclosure. As used herein, the singular forms “a”, “an”, and “the” are intended to include the plural forms as well, unless the context clearly indicates otherwise. Furthermore, the use of the terms “a”, “an”, etc., do not denote a limitation of quantity, but rather denote the presence of at least one of the referenced items. It will be further understood that the terms “comprises” and/or “comprising”, or “includes” and/or “including”, when used in this specification, specify the presence of stated features, regions, integers, steps, operations, elements, and/or components, but do not preclude the presence or addition of one or more other features, regions, integers, steps, operations, elements, components, and/or groups thereof. Moreover, as used herein, the term RAID means redundant array of independent disks (originally redundant array of inexpensive disks). In general, RAID technology is a way of storing the same data in different places (thus, redundantly) on multiple hard disks. By placing data on multiple disks, I/O (input/output) operations can overlap in a balanced way, improving performance. Since multiple disks increase the mean time between failures (MTBF), storing data redundantly also increases fault tolerance. The term SSD means semiconductor storage device. The term flash memory means double data rate. Still yet, the term HDD means hard disk drive.

Unless otherwise defined, all terms (including technical and scientific terms) used herein have the same meaning as commonly understood by one of ordinary skill in the art. It will be further understood that terms such as those defined in commonly used dictionaries should be interpreted as having a meaning that is consistent with their meaning in the context of the relevant art and the present disclosure, and will not be interpreted in an idealized or overly formal sense unless expressly so defined herein.

Hereinafter, a RAID storage device of an I/O standard such as a serial attached small computer system interface (SAS)/serial advanced technology attachment (SAIA) type according to an embodiment will be described in detail with reference to the accompanying drawings.

As indicated above, embodiments of the present invention provide a semiconductor storage device (SSD) system based on redundant array of independent disks (RAID) controller collaboration. Specifically, embodiments of the present invention provide a set (at least one) of RAID controllers coupled to a host system, wherein each of the set of RAID controllers is configured to collaborate with at least one other RAID controller within the set through at least one dedicated controller-to-controller channel to enable high bandwidth RAID storage. Each of the set of RAID controllers controls a set (at least one) of storage drives.

The storage device of an I/O standard such as a serial attached small computer system interface (SAS)/serial advanced technology attachment (SATA) type supports a low-speed data processing speed for a host by adjusting synchronization of a data signal transmitted/received between the host and a memory disk during data communications between the host and the memory disk through a PCI-Express interface, and simultaneously supports a high-speed data processing speed for the memory disk, thereby supporting the performance of the memory to enable high-speed data processing in an existing interface environment at the maximum. It is understood in advance that although PCI-Express technology will be utilized in a typical embodiment, other alternatives are possible. For example, the present invention could utilize SAS/SATA technology in which a SAS/SATA type storage device is provided that utilizes a SAS/SATA interface.

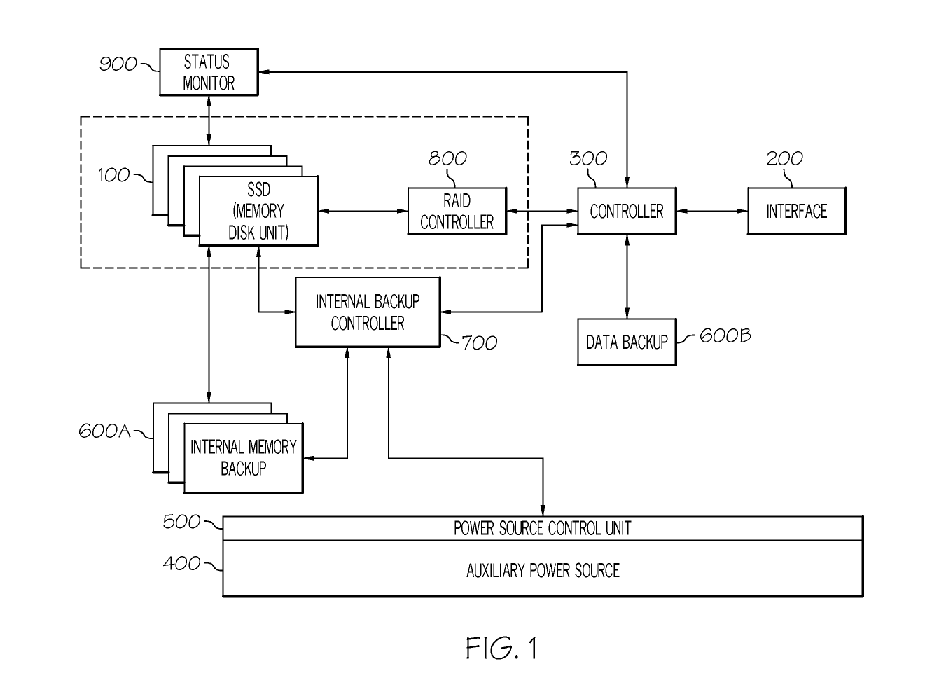

Referring now to FIG. 1, a diagram schematically illustrating a configuration of a PCI-Express type, RAID controlled storage device (e.g., for providing storage for a serially attached computer device) according to an embodiment of the invention is shown. As depicted, FIG. 1 shows a RAID controlled PCI-Express type storage device according to an embodiment of the invention which includes a memory disk unit 100 comprising: a plurality of memory disks having a plurality of volatile and non-volatile semiconductor memories (also referred to herein as high-speed SSDs 100); a RAID controller 800 coupled to SSDs 100; an interface unit 200 (e.g., PCI-Express host) which interfaces between the memory disk unit and a host; a controller unit 300; an auxiliary power source unit 400 that is charged to maintain a predetermined power using the power transferred from the host through the PCI-Express host interface unit; a power source control unit 500 that supplies the power transferred from the host through the PCI-Express host interface unit to the controller unit, the memory disk unit, the backup storage unit, and the backup control unit which, when the power transferred from the host through the PCI-Express host interface unit is blocked or an error occurs in the power transferred from the host, receives power from the auxiliary power source unit and supplies the power to the memory disk unit through the controller unit; a backup storage unit 600A-B that stores data of the memory disk unit; and a backup control unit 700 that backs up data stored in the memory disk unit in the backup storage unit, according to an instruction from the host or when an error occurs in the power transmitted from the host.

The memory disk unit 100 includes a plurality of memory disks provided with a plurality of volatile semiconductor memories for high-speed data input/output (for example, flash memory, flash memory2, flash memory3, SDRAM, and the like), and inputs and outputs data according to the control of the controller 300. The memory disk unit 100 may have a configuration in which the memory disks are arrayed in parallel.

The PCI-Express host interface unit 200 interfaces between a host and the memory disk unit 100. The host may be a computer system or the like, which is provided with a PCI-Express interface and a power source supply device.

The controller unit 300 adjusts synchronization of data signals transmitted/received between the PCI-Express host interface unit 200 and the memory disk unit 100 to control a data transmission/reception speed between the PCI-Express host interface unit 200 and the memory disk unit 100.

As depicted, a PCI-e type RAID controller 800 can be directly coupled to any quantity of SSDs 100. Among other things, this allows for optimum control of SSDs 100. Among other things, the use of a RAID controller 800:
1. Supports the current backup/restore operations.
2. Provides additional and improved backup function by performing the following:
   a) the internal backup controller determines the backup (user's request order or the status monitor detects power supply problems);
   b) the internal backup controller requests a data backup to SSDs;
   c) the internal backup controller requests internal backup device to backup data immediately;
   d) monitors the status of the backup for the SSDs and internal backup controller; and
   e) reports the internal backup controller's status and end-op.
3. Provides additional and improved restore function by performing the following:
   a) the internal backup controller determines the restore (user's request order or the status monitor detects power supply problems);
   b) the internal backup controller requests a data restore to the SSDs;
   c) the internal backup controller requests internal backup device to restore data immediately;
   d) monitors the status of the restore for the SSDs and internal backup controller; and
   e) reports the internal backup controller status and end-op.

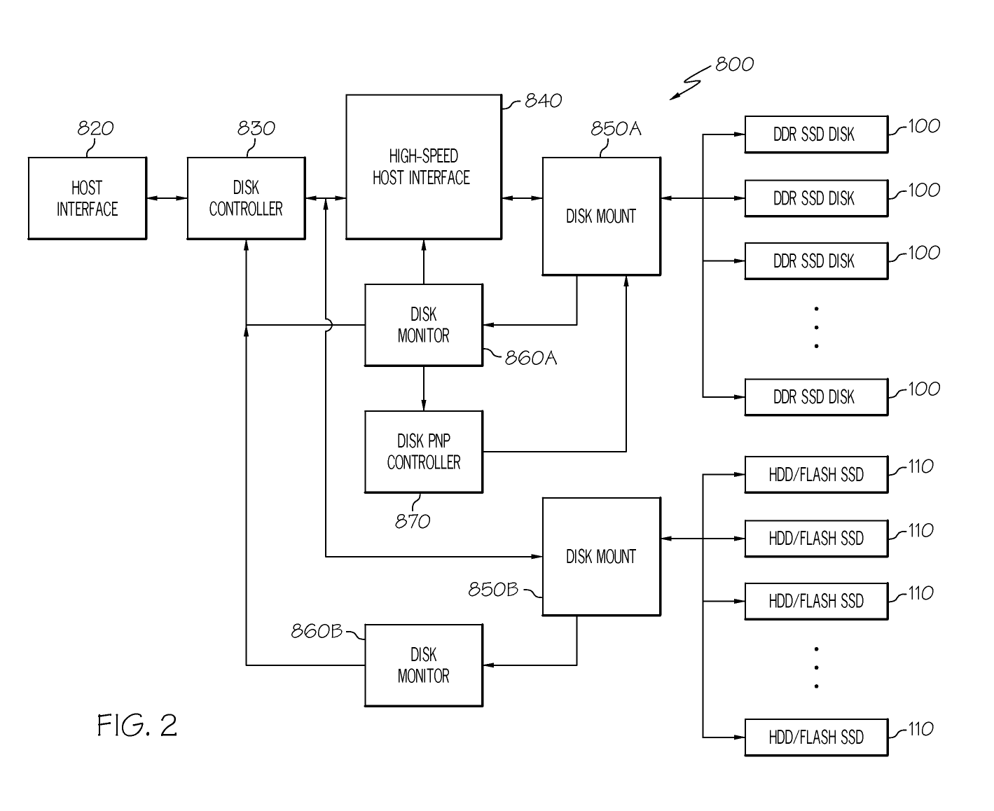

Referring now to FIG. 2, a diagram of the hybrid RAID controller 800 of FIG. 1 as coupled to a set (at least one) of SSD memory disk units 100 and a set of HDD/flash memory units is shown in greater detail (collectively shown as unit 100 in FIG. 1). As depicted, hybrid RAID controller 800 generally comprises: a host interface 820; a disk controller 830 coupled to host interface 820; and a high-speed host interface 840. Also coupled to disk controller 830 is a first disk monitoring unit 860A, which is coupled to the first disk mount 850A. In general, SSD memory disk units 100 are mounted on first disk mount 850A and are detected by first disk monitoring unit 860A. Still yet, shown coupled to disk controller 830 is a second disk monitoring unit 860B, which is coupled to a second disk mount 850B. In general, HDD/Flash memory units 110 are mounted on second disk mount 850B and are detected by second disk monitoring unit 860B. Disk plug and play (PnP controller 870) controls the functions and/or detection functions related to first disk mount 850A and second disk mount 850B. In general, hybrid RAID controller 800 controls the operation of SSD memory disk units 100 and HDD/Flash memory units 110. This includes the detection of SSD memory disk units 100 and HDD/Flash memory units 110, the storage and retrieval of data therefrom, etc.

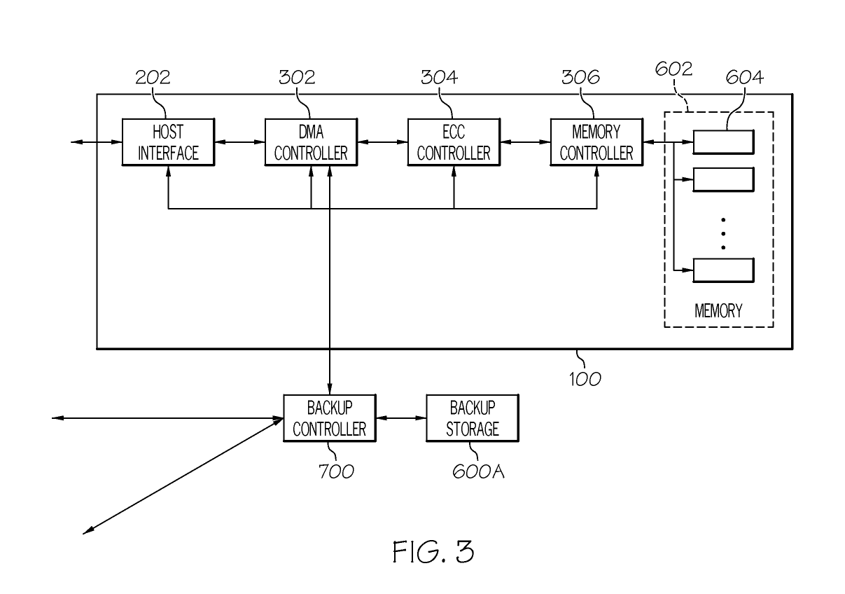

Referring now to FIG. 3, a diagram schematically illustrating a configuration of the high-speed SSD 100 is shown. As depicted, SSD/memory disk unit 100 comprises: a host interface 202 (e.g., PCI-Express host) (which can be interface 200 of FIG. 1, or a separate interface as shown); a DMA controller 302 interfacing with a backup control module 700; an ECC controller 304; and a memory controller 306 for controlling one or more blocks 604 of memory 602 that are used as high-speed storage.

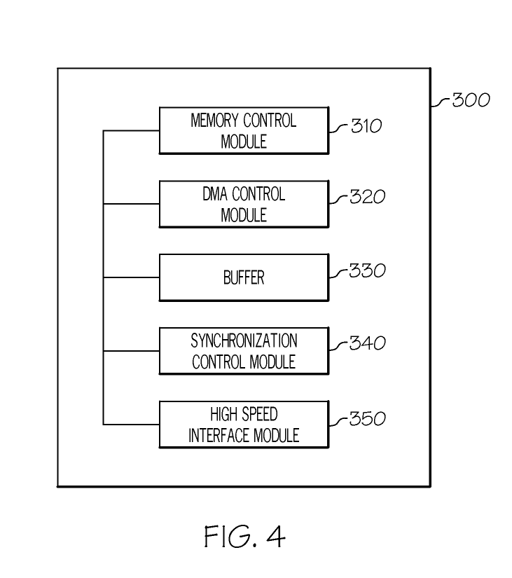

Referring now to FIG. 4, the controller unit 300 of FIG. 1 is shown as comprising: a memory control module 310 which controls data input/output of the SSD memory disk unit 100; a DMA control module 320 which controls the memory control module 310 to store the data in the SSD memory disk unit 100, or reads data from the SSD memory disk unit 100 to provide the data to the host, according to an instruction from the host received through the PCI-Express host interface unit 200; a buffer 330 which buffers data according to the control of the DMA control module 320; a synchronization control module 340 which, when receiving a data signal corresponding to the data read from the SSD memory disk unit 100 by the control of the DMA control module 320 through the DMA control module 320 and the memory control module 310, adjusts synchronization of a data signal so as to have a communication speed corresponding to a PCI-Express communications protocol to transmit the synchronized data signal to the PCI-Express host interface unit 200, and when receiving a data signal from the host through the PCI-Express host interface unit 200, adjusts synchronization of the data signal so as to have a transmission speed corresponding to a communications protocol (for example, PCI, PCI-x, or PCI-e, and the like) used by the SSD memory disk unit 100 to transmit the synchronized data signal to the SSD memory disk unit 100 through the DMA control module 320 and the memory control module 310; and a high-speed interface module 350 which processes the data transmitted/received between the synchronization control module 340 and the DMA control module 320 at high speed. Here, the high-speed interface module 350 includes a buffer having a double buffer structure and a buffer having a circular queue structure, and processes the data transmitted/received between the synchronization control module 340 and the DMA control module 320 without loss at high speed by buffering the data and adjusting data clocks.

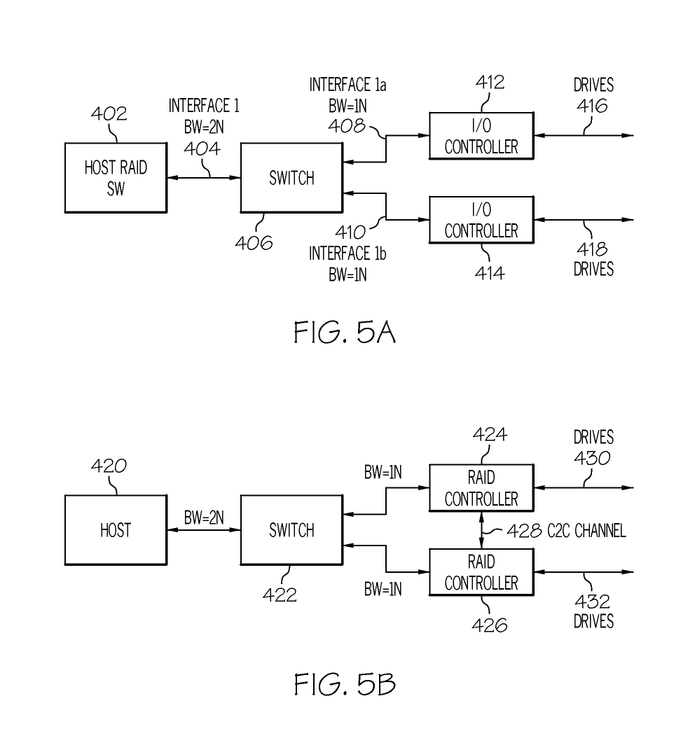

FIG. 5A is a diagram schematically illustrating a configuration of a conventional wide bandwidth RAID. RAID is a technology that employs the simultaneous use of multiple storage drives to achieve greater levels of performance, reliability, and/or larger data volume sizes. This is achieved by presenting multiple hard drives as a single storage volume which simplifies storage management. In FIG. 5A, host RAID software 402 is utilized by controller switch 406 via interface 404. I/O (input/output) controller 412 is coupled to switch 406 via interface 408. I/O controller 414 is coupled to switch 406 via interface 410. Drives 416 are coupled to I/O controller 412. Drives 418 are coupled to I/O controller 414.

Software-based RAID implementations are either operating system-based, or they are application programs that run on the server. All array operations and management functions are controlled by the array software running on the host. Software-based RAID implementations require custom design which adds costs and complexity. Furthermore, software-based RAID lacks reliability, occupies host system memory, consumes central processing unit (CPU) cycles, and is operating system dependent. The performance of a software-based array is directly dependent on server CPU performance and load.

FIG. 5B is a diagram schematically illustrating a configuration of a collaborating wide bandwidth RAID. Unlike a software-based array, a hardware-based array is implemented directly on a host-based RAID adapter and tightly couples the array functions with the disk interface. Hardware arrays do not occupy any host system memory, nor are they operating system dependent. In FIG. 5B, controller switch 422 is coupled to host 420. Multiple RAID controllers are used to manage sufficient system I/O bandwidth. RAID controller 424 is coupled to switch 422. RAID controller 426 is coupled to switch 422. Drives 430 are coupled to RAID controller 424. Drives 432 are coupled to RAID controller 426. Fast solid-stage disk storage systems require a high-bandwidth channel to host to take advantage of SSD performance. RAID controller 424 and RAID controller 426 communicate with each other through dedicated controller-to-controller channel (C2C) 428 to enable system-wide RAID. Host 420 sees RAID controller array as a single RAID.

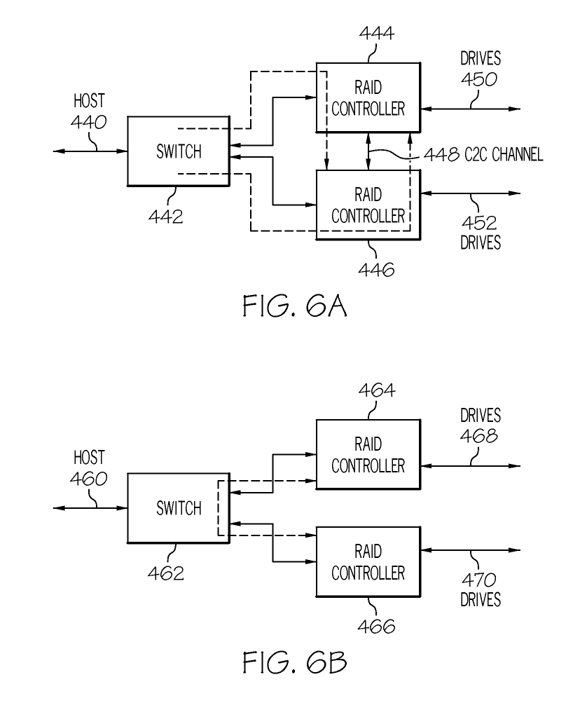

FIG. 6A is a diagram schematically illustrating a switch enabled to distribute the data load to a set of collaborating RAID controllers. Control switch 442 is coupled to host computer 440. RAID controller 444 is coupled to switch 442. RAID controller 446 is coupled to switch 442. Drives 450 are coupled to RAID controller 444. Drives 452 are coupled to RAID controller 446. C2C channel 448 allows the two RAID controllers to communicate with one another. FIG. 6A is a more detailed view of the communications among switch 442 and RAID controllers 444, 446. Host computer 440 sees multiple RAID controllers as one controller because of switch 442. Switch 442 distributes the load to the different controllers. The RAID controllers communicate with each other through dedicated controller-to-controller channel 448 for extended RAID operation. For example, if RAID controller 444 is required to communicate with RAID controller 446 to retrieve a piece of data housed in drives 452, RAID controller 446 returns the result to switch 442 directly or return through the original controller (RAID controller 444).

FIG. 6B is a diagram schematically illustrating a switch adapted to intercept and dynamically forward data to enable controller-to-controller communication for wider bandwidth. Similar to the previous figure, control switch 462 is coupled to host computer 460. RAID controller 464 is coupled to switch 462. RAID controller 466 is coupled to switch 462. Drives 468 are coupled to RAID controller 464. Drives 470 are coupled to RAID controller 466. Switch 462 can selectively intercept and dynamically forward data to enable controller-to-controller communication for wider bandwidth.

In FIG. 6B, switch 462 acts as the communication bridge between the controllers, rather than having communications between controllers through a C2C channel as previously discussed. Switch 462 takes on this functionality when RAID controller to RAID controller communication channel bandwidth is narrow or non-existent. Also, if there is a catastrophic failure or hot-swap at a drive, the hot-spare is brought to a RAID controller and all RAID information has to be redistributed due to recovery and disk rebuilding activities. Such activity requires vast amounts of data transaction between disks and RAID controllers, while the entire RAID system becomes less responsive due to the rebuilding effort. In this case, a portion of channel bandwidth to the host will be used temporarily.

Referring back to FIG. 1, auxiliary power source unit 400 may be configured as a rechargeable battery or the like, so that it is normally charged to maintain a predetermined power using power transferred from the host through the PCI-Express host interface unit 200 and supplies the charged power to the power source control unit 500 according to the control of the power source control unit 500.

The power source control unit 500 supplies the power transferred from the host through the PCI-Express host interface unit 200 to the controller unit 300, the memory disk unit 100, the backup storage unit 600, and the backup control unit 700.

In addition, when an error occurs in a power source of the host because the power transmitted from the host through the PCI-Express host interface unit 200 is blocked, or the power transmitted from the host deviates from a threshold value, the power source control unit 500 receives power from the auxiliary power source unit 400 and supplies the power to the memory disk unit 100 through the controller unit 300.

The backup storage unit 600A-B is configured as a low-speed non-volatile storage device such as a hard disk and stores data of the memory disk unit 100.

The backup control unit 700 backs up data stored in the memory disk unit 100 in the backup storage unit 600A-B by controlling the data input/output of the backup storage unit 600A-B and backs up the data stored in the memory disk unit 100 in the backup storage unit 600A-B according to an instruction from the host, or when an error occurs in the power source of the host due to a deviation of the power transmitted from the host deviates from the threshold value.

While the exemplary embodiments have been shown and described, it will be understood by those skilled in the art that various changes in form and details may be made thereto without departing from the spirit and scope of this disclosure as defined by the appended claims. In addition, many modifications can be made to adapt a particular situation or material to the teachings of this disclosure without departing from the essential scope thereof. Therefore, it is intended that this disclosure not be limited to the particular exemplary embodiments disclosed as the best mode contemplated for carrying out this disclosure, but that this disclosure will include all embodiments falling within the scope of the appended claims.

The present invention supports a low-speed data processing speed for a host by adjusting synchronization of a data signal transmitted/received between the host and a memory disk during data communications between the host and the memory disk through a PCI-Express interface and simultaneously supports a high-speed data processing speed for the memory disk, thereby supporting the performance of the memory to enable high-speed data processing in an existing interface environment at the maximum.

The foregoing description of various aspects of the invention has been presented for purposes of illustration and description. It is not intended to be exhaustive or to limit the invention to the precise form disclosed and, obviously, many modifications and variations are possible. Such modifications and variations that may be apparent to a person skilled in the art are intended to be included within the scope of the invention as defined by the accompanying claims.

What is claimed is:

1. A semiconductor storage device (SSD) system architecture based on redundant array of independent disks (RAID) controller collaboration, comprising:
a controller switch coupled to a host computer;
a set of RAID controllers coupled to the controller switch, wherein each of the set of RAID controllers is adapted to collaborate with at least one other RAID controller within the set; and
a set of storage drives coupled to each of the set of RAID controllers.

2. The system of claim 1, wherein the collaboration between any two RAID controllers is performed via a dedicated controller-to-controller channel.

3. The system of claim 1, wherein the host computer recognizes the set of RAID controllers as a single RAID controller.

4. The system of claim 1, wherein the controller switch distributes the load to the RAID controllers based on predefined criteria.

5. The system of claim 1, wherein a first RAID controller in the set of RAID controllers is adapted to communicate a data request be performed by a second RAID controller in the set, and the second RAID controller is adapted to fulfill the request and return the result of the request directly to the controller switch.

6. The system of claim 1, wherein a first RAID controller in the set of RAID controllers is adapted to communicate a data request be performed by a second RAID controller in the set, and the second RAID controller is adapted to fulfill the request and return the result of the request to the first RAID controller.

7. The system of claim 1, wherein the controller switch is adapted to intercept and forward data to enable RAID controller collaboration.

8. A method for providing a semiconductor storage device (SSD) system architecture based on redundant array of independent disks (RAID) controller collaboration, comprising:
a controller switch coupled to a host computer;
a set of RAID controllers coupled to the controller switch, wherein each of the set of RAID controllers is adapted to collaborate with at least one other RAID controller within the set; and
a set of storage drives coupled to each of the set of RAID controllers.

9. The method of claim 8, wherein the collaboration between any two RAID controllers is performed via a dedicated controller-to-controller channel.

10. The method of claim 8, wherein the host computer recognizes the set of RAID controllers as a single RAID controller.

11. The method of claim 8, wherein the controller switch distributes the load to the RAID controllers based on predefined criteria.

12. The method of claim 8, wherein a first RAID controller in the set of RAID controllers is adapted to communicate a data request be performed by a second RAID controller in the set, and the second RAID controller is adapted to fulfill the request and return the result of the request directly to the controller switch.

13. The method of claim 8, wherein a first RAID controller in the set of RAID controllers is adapted to communicate a data request be performed by a second RAID controller in the set, and the second RAID controller is adapted to fulfill the request and return the result of the request to the first RAID controller.

14. The method of claim 8, wherein the controller switch is adapted to intercept and forward data to enable RAID controller collaboration

15. A configurable disk array system for controlling storing and retrieving of data in RAID format, comprising:
a controller switch coupled to a host computer;
a set of RAID controllers coupled to the controller switch, wherein each of the set of RAID controllers is adapted to collaborate with at least one other RAID controller within the set; and
a set of storage drives coupled to each of the set of RAID controllers.

16. The system of claim 15, wherein the collaboration between any two RAID controllers is performed via a dedicated controller-to-controller channel.

17. The system of claim 15, wherein the host computer recognizes the set of RAID controllers as a single RAID controller.

18. The system of claim 15, wherein the controller switch distributes the load to the RAID controllers based on predefined criteria.

19. The system of claim 15, wherein a first RAID controller in the set of RAID controllers is adapted to communicate a data request be performed by a second RAID controller in the set, and the second RAID controller is adapted to fulfill the request and return the result of the request directly to the controller switch.

20. The system of claim 15, wherein a first RAID controller in the set of RAID controllers is adapted to communicate a data request be performed by a second RAID controller in the set, and the second RAID controller is adapted to fulfill the request and return the result of the request to the first RAID controller.

21. The system of claim 15, wherein the controller switch is adapted to intercept and forward data to enable RAID controller collaboration.
